(19) United States
(12) Patent Application Publication
(10) Pub. No.: US 2010/0187834 A1
(43) Pub. Date: Jul. 29, 2010

(54) SYSTEM AND METHOD FOR GENERATING ELECTRICAL ENERGY

(76) Inventor: Kenneth C. Brooks, Los Gatos, CA (US)

Correspondence Address: Law Office of Kenneth C. Brooks, P.O. Box 321120, Los Gatos, CA, 95032, US

(21) Appl. No.: 12/360,574

(22) Filed: Jan. 27, 2009

(51) Int. Cl. H02K 7/18; F03B 17/04

(52) U.S. Cl. 290/1 R; 74/DIG. 9

(57) ABSTRACT

In accordance with embodiments, there are provided systems and method for generating electrical energy that includes a resilient member having an original shape with a cruciform cross-section. A bulwark is connected to the resilient member. A system is provided to selectively apply a torsional force to the resilient member using capillary forces to rotate the resilient member with respect to the bulwark. This places the resilient member in a deformed shape. The system also selectively terminates the capillary forces allowing the resilient member to return to the original shape. An electrical generator subsystem having a rotor and a stator is included. The rotor is coupled to the resilient member to spin in response to the resilient member changing from the deformed shape to the original shape.

### FIELD OF THE INVENTION

The current invention relates electrical generators. More particularly the current invention relates to a system that produces electrical energy.

### BACKGROUND

The human race has long sought to ease the labor involved with movement of bodies. Arguably it can be asserted that the nascent of this labor saving technology began with the wheel and has evolved into many types of vehicles including automobiles, ships, aircraft and rockets. Key to the advancement of this technology is the generation of energy to move the same. Domestication of animals produced some of the earliest implementations of energy required for early transports, e.g., oxen, bulls and horses, followed by harnessing of the terrestrial forces of the earth to move ships across bodies of water.

Progress resulted in the human race abandoned commercial use of relatively benign sources of energy in favor of destructive sources that typically involved a combustion process. Long used to generate heat for warmth the relatively archaic practice of consuming wood to heat water brought about the steam engine. Originally invented by the ancient Greeks some four thousand years ago, modern implementations of steam power resulted in steam-powered ships, trains and automobiles. Realizing the limitations of wood, coal soon became a primary source of combustible material and competed vigorously with another source of combustible material, crude oil. Coal lost favor due to the pollution it produced. The steam engine has been provided a brief respite using nuclear fission as the source of heat. The enormous amounts of crude oil required to construct nuclear power plants and dispose of nuclear waste coupled with the pollution generated thereby makes this form of energy generation inefficient and caustic. Today crude oil is the dominant resource used to generate energy.

There is a need, therefore, to produce new techniques to generate energy that avoids the consequences of current energy producing techniques.

### BRIEF SUMMARY

In accordance with embodiments, there are provided systems and method for generating electrical energy that includes a resilient member having an original shape. A bulwark is connected to the resilient member. A system is provided to selectively apply a torsional force to the resilient member using capillary forces to rotate the resilient member with respect to the bulwark. This places the resilient member in a deformed shape. The system also selectively terminates the capillary forces allowing the resilient member to return to the original shape. An electrical generator subsystem having a rotor and a stator is included. The rotor is coupled to the resilient member to spin in response to the resilient member changing from the deformed shape to the original shape. These and other embodiments are described more fully below.

### BRIEF DESCRIPTION OF THE DRAWINGS

FIG. 1 is a simplified plan view of an electrical generator in accordance with the present embodiment;

FIG. 2 is detailed side view of a potential-kinetic energy (PKE) sub-system shown in FIG. 1, in accordance with one embodiment;

FIG. 3 is a cross-sectional view of a resilient member, shown in FIG. 2, taken along lines 3-3;

FIG. 4 is a cross-sectional view of a body shown in FIG. 2;

FIG. 5 is a partial bottom up view of the body shown in FIG. 3;

FIG. 6 is a detailed side view of one end of a resilient member shown in FIG. 2;

FIG. 7 is a bottom view of a rotor of an electrical system, shown in FIG. 1;

FIG. 8 is a cross-sectional view of a portion of the rotor shown in FIG. 7, taken along lines 8-8;

FIG. 9 is a detailed side view of one end of a resilient member shown in FIG. 2;

FIG. 10 is a cross-sectional view of a portion of the one end of the resilient member, shown in FIG. 9, taken along lines 10-10;

FIG. 11 is a simplified plan view showing the spatial relationship between the cross-section views shown in FIGS. 8 and 10 upon the rotor seated upon the resilient member, in accordance with the present invention;

FIG. 12 is a detailed side view of the (PKE) sub-system, shown in FIG. 1, in accordance with a second embodiment;

FIG. 13 is a top down view of a journal member shown in FIG. 12;

FIG. 14 is a detailed side view of the (PKE) sub-system, shown in FIG. 12, in accordance with an alternate embodiment; and

FIG. 15 is a simplified top down view of the system shown in FIG. 8.

### DETAILED DESCRIPTION

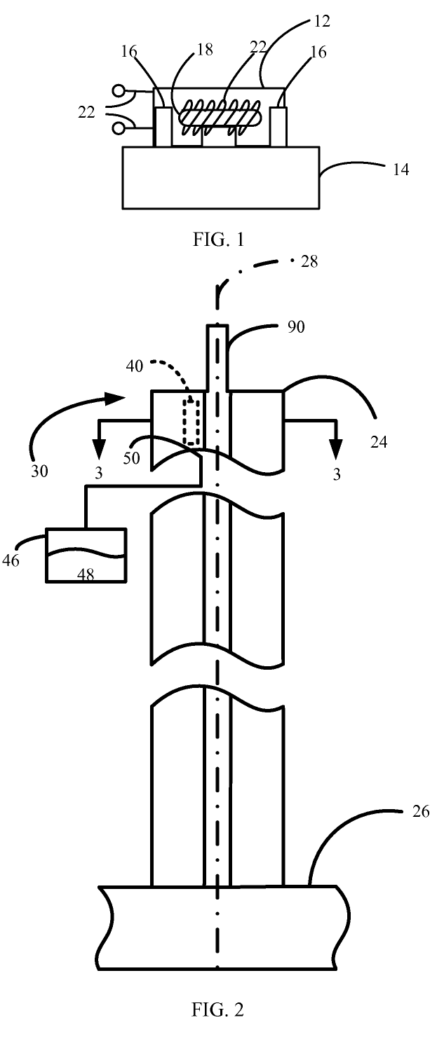

Referring to FIG. 1, an example of a generator 10 in accordance with one embodiment of the present invention that includes a potential-kinetic energy (PKE) sub-system 12 and an electrical generator sub-system 14 coupled to PKE sub-system 12. PKE sub-system 12 selectively stores potential energy and generates kinetic energy. The kinetic energy generated by PKE sub-system 12 is transferred to electrical generator sub-system 14. In response to the kinetic energy to which electrical generator sub-system 14 is exposed, an induced electromotive force EFM is produced based upon well known principles of Faraday's law and generating electricity using alternators. To that end, electrical generator sub-system 14 includes a stator 16 and a rotor 18. In this present example, rotor 18 is magnetic and stator 16 includes electrically conductive wire wound around an insulator defining windings 20. Movement of rotor 18 produces a time-varying magnetic flux that induces EMF in windings 20, as is well known in the art that may be transmitted to systems (not shown) that operate on electrical power using conductive wires 22.

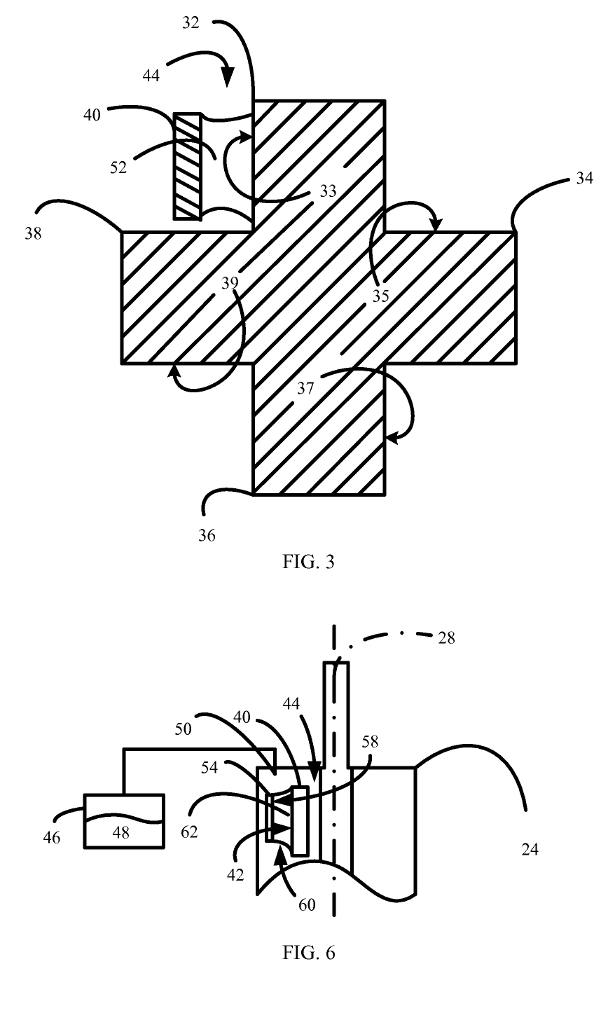

Referring to both FIGS. 1 and 2, PKE 12 operates in accordance with Hooke's law in which potential energy is produced as a result of applying a force to deform a resilient member 24 included therewith. Resilient member 24 may be fixedly attached to a bulwark 26 or integrally formed therewith. Resilient member 24 extends from bulwark 26 along an axis 28 terminating in an end 30. In the present embodiment resilient member 24 is a torsional spring to which torsional forces are selectively applied to twist resilient member 24 causing regions thereof to rotate about axis 28, placing resilient member 24 in a deformed shape. In the absence of torsional forces, resilient member 24 has an original shape. Upon termination of torsional forces resilient member 24 returns to the original shape. As a result, it is desired to form resilient member 24 from material that maintains adequate structural memory to return to the original shape after be placed in the deformed shape. Examples of materials from which resilient member 24 may be fabricated include stainless steel, aluminum, titanium, polymers, metallic alloys and the like.

Referring to both FIGS. 2 and 3, in the present example resilient member 24 has a cruciform cross-section defining a plurality of shoulders, shown as 32, 34, 36 and 38. Each of shoulders 32, 34, 36 and 38 includes a surface 33, 35, 37 and 39, respectively. One or more of surfaces 33, 35, 37 and 39 is spaced-apart from one or more bodies, shown as body 40 spaced-apart from surface 33. Specifically, body 40 includes a surface 42 that is spaced-apart from surface 33, defining a volume 44 therebetween.

A supply 46 of fluid 48 includes an egress 50 positioned to deposit a portion 52 of fluid 48 into volume 44, using any known techniques to create a flow through egress, e.g., positive pressure applied to volume supply 46. The viscosity of portion 52 and dimensions of volume 44 are established so that upon application of portion 52, to one or both surfaces 33 and 42, capillary action occurs pulling surface 33 and 42 closer together, reducing the distance therebetween. Body 40 may be coupled with respect to bulwark 26 so that a distance between axis 28 and surface 42 may be controlled, e.g., by direct attachment to bulwark (not shown for the sake of clarity) or by being fixedly attached to another body (not shown), the position of which is fixed with respect to bulwark 26. With this configuration, the capillary action results in the movement of surface 33 toward surface 42. This is believed to occur as a result of intermolecular forces between the molecules of portion 52 and surfaces 33 and 42 that subjects resilient member 24 to a torsional force τ, which is in a direction away from body 40.

Torsional force τ₁ causes twisting of resilient member 24 about axis 28, deforming resilient member 24. Deformation of resilient member 24 produces a restoring force F_{R} in accordance with Hooke's law and which is in a direction away from surface 42. After completion of rotational movement, resilient member 24 is in a deformed state. In the deformed state, restoring force F_{R} and torsional force τ are substantially at equilibrium, i.e. no further movement of resilient member 24 occurs. In this manner, resilient member 24 stores potential energy.

The potential energy stored in resilient member 24 may be released by disturbing the aforementioned equilibrium. This may be achieved in any convenient manner. For example, a mechanical force may be applied to body 40 causing a distance between body 40 and axis 28 to increase, i.e., applying a pulling force F_{P} that moves in a direction away from body 40. Pulling force F_{P} is of sufficient strength to overcome the intermolecular forces that exist between portion 52 and surface 33 and 42, referred to as release of intermolecular force, i.e., release. Specifically, the combination of restoring force F_{R} and pulling force F_{P} acting in opposite directions disrupts the aforementioned equilibrium and degrades the capillary action of portion 52. In response, resilient member 24 returns to the original shape by undergoing rotation about longitudinal axis 28. Resilient member 24 produces kinetic energy as it transforms between the deformed shape to the original shape. Upon reaching the original shape, resilient member 24 ceases rotating and once again defines volume 44, at which point both the potential energy and kinetic energy of resilient member 24 returns to zero. With restoring force F_{R} and pulling force F_{P} operating synergistically to terminate torsional force τ, it is not necessary that pulling force F_{P} have a magnitude that is commensurate with either restoring force F_{R} or torsional force τ. Pulling force F_{P} need only be sufficient to disrupt the equilibrium that exists when restoring force F_{R} is produced in response to resilient member 24 being subjected to torsional force τ. In one example, pulling force F_{P} is applied manually with the use of one or more levers (not shown) that may be attached to either resilient member 24 and/or body 40.

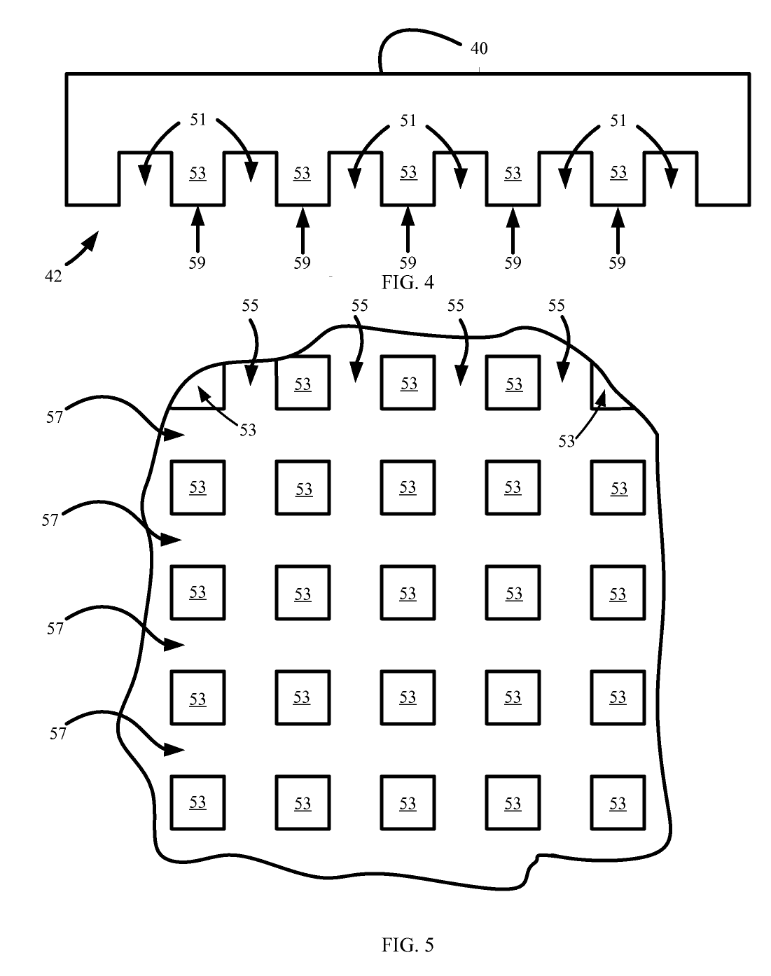

Referring to FIGS. 3, 4 and 5, to facilitate capillary action, body 40 may include a surface 42 that is featured. In this configuration surface includes a plurality of recessions 51 defining a plurality of spaced-apart protrusions 53. As shown recessions associated with a first subset 55 of recessions 51 extend parallel to each other along a first direction. Recessions associated with a second subset 57 of recession 51 extending parallel to one another along a second direction that is orthogonal to the first direction. In this manner, protrusions 53 have a rectangular cross-section and are spaced-apart from an adjacent protrusion 53 a distance 61. It is desired in this configuration that surface 33 have a substantially smooth, in not planar profile. Additionally, it is desired that an apex surface 59 of each of protrusions 53 lie in a common plane that extends parallel to a plane in which surface 33 lies, defining a depth 63 for each recession 51. It should be noted that capillary action may be achieved satisfactorily upon reversal of the patterned in smooth surfaces such that surface 33 is patterned as discussed above with respect to surface 42 and surface 42 having the profile of surface 33. In an alternative embodiment, both surfaces 33 and 42 may be substantially smooth, if not planar. In this configuration, however, it is desired that surface 33 extend parallel to surface 42. The present configuration is discussed with respect to surface 42 being patterned and surface 33 being smooth.

The magnitude of the capillary action provided by portion 52 is directly related to the 52 number of surface interactions between the molecules included in portion 50 and surfaces 42 and 33. To that end, it is desired that spacing 61 and depth 63 be established with respect to the size of molecules in portion 52 to provide rapid capillary action when surface 42 is disposed proximate to surface 33, with the exact dimensions being dependent upon the desired rate of capillary action. One example, provide spacing 61 and depth 63 with dimensions on the order of tens of nanometers to several 100 nanometers with the molecules in portion having dimensions smaller that either spaced 61 and/or depth 63. Additionally, portion have very low viscosity to provide rapid filling of volume 44, which includes recessions 51. An example of a low viscosity fluid is formed from isobornyl acrylate (IBOA) and n-hexyl acrylate (n-HA). An example of a composition of portion 52 comprises approximately 70 to 75% IBOA and 25-30% n-HA by weight which is believed to provide a viscosity in a range 2 to 10 Centipoises.

In an alternate configuration shown in FIG. 6, pulling force F_{P} is applied through implementation of a secondary body 54, which may be attached to bulwark as discussed above with respect to body 40. Secondary body 54 has a surface 58 that is in juxtaposition with surface 42 and is spaced-apart therefrom, defining a volume 60 therebetween upon restoring force F_{R} and torsional force τ reaching equilibrium. Volume 60 has dimensions sufficient so that an additional portion 62 of fluid 48 may be disposed therein creating capillary action so that surface 58 moves toward surface 42 a sufficient distance to provide pulling force F_{P} with a desired magnitude. It is believed that the kinetic energy produced by resilient member 24 may be attenuated during release and that the magnitude of attenuation may be inversely proportional to the rate at which the capillary action between portion 52 and surface 33 and 42 is degraded and/or abrogated. This is believed to be proportional to the magnitude of pulling force F_{P} and the rate at which pulling force F_{P} is applied to body 40. In the present configuration pulling force F_{P} is applied as instantaneous as possible with the result being that the magnitude of attenuation of the kinetic energy produced by rotation of resilient member 24 from the deformed shape to the original shape being inversely proportional to the magnitude of pulling force F_{P}. The kinetic energy produced by resilient member 24, shown in FIG. 1, is transferred to rotor 18 by coupling rotor 18 to an end 30 of resilient member 24 disposed opposite to bulwark 26, shown in FIG. 2.

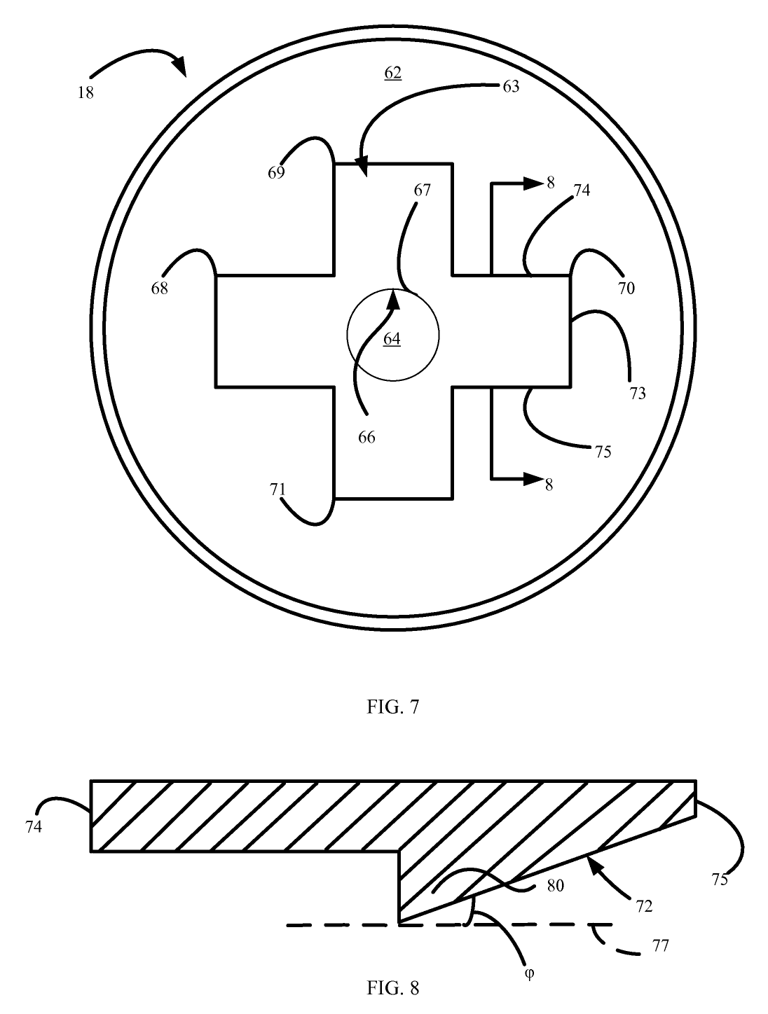

Referring to FIGS. 2, 7 and 8, it is desired that rotor 18 be allowed to spin freely with respect resilient member 24 in at least one direction. To that end, surface 62 of rotor 18 facing end 30 has a profile that is partially complementary to the profile of end 30. Surface 62 includes a projection 63 and a centrally disposed hollow that extends from a radially symmetric bearing surface 64 and defining a circumferential surface 66, terminating in an opening 67 within projection 63. Circumferential surface 66 is substantially smooth. Regions of projection 63 extending from opening 67 form a cruciform profile having four serif portions 68, 69, 70 and 71. Each serif portion 68-71 includes an oblique surface 72 extending from opening 67 and terminating in a transverse side 73. Opposed sides 74 and 75 extend from transverse side 73, parallel to one another and transversely to transverse side 73, terminating in adjacent serif portions 69-71. Oblique surface 72 extends from side 75, forming an oblique angle φ with respect to a plane 77, terminating spaced-apart from opposing side 74 defining a shoulder 80. In this configuration plane 77 extends parallel to surface 62 and orthogonally to axis 28.

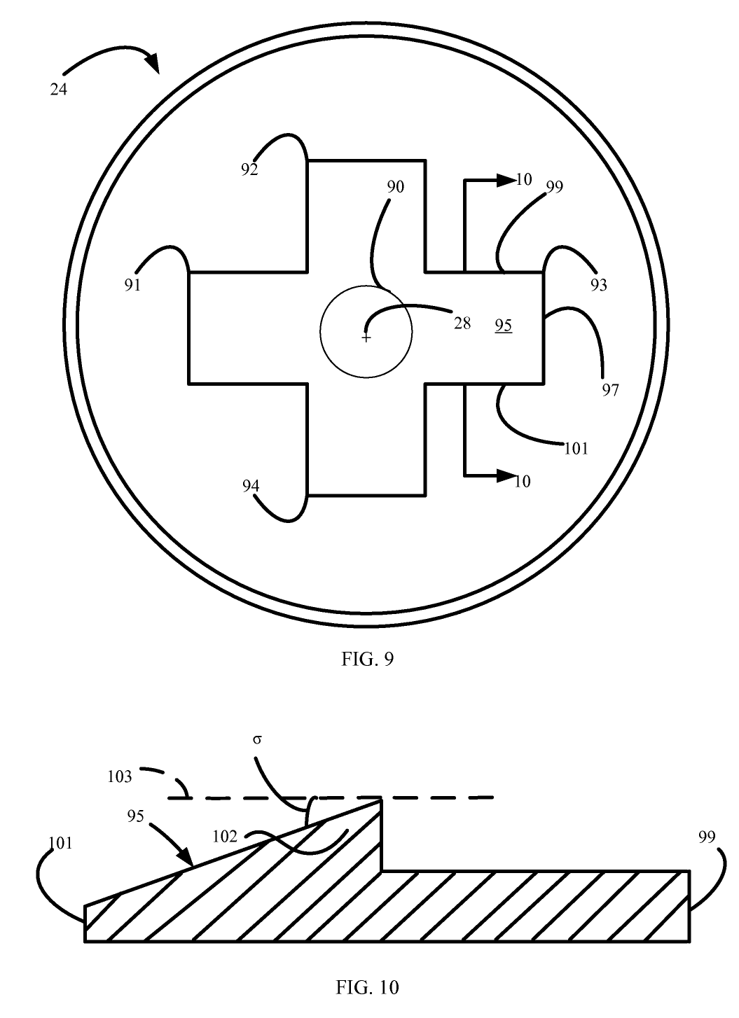

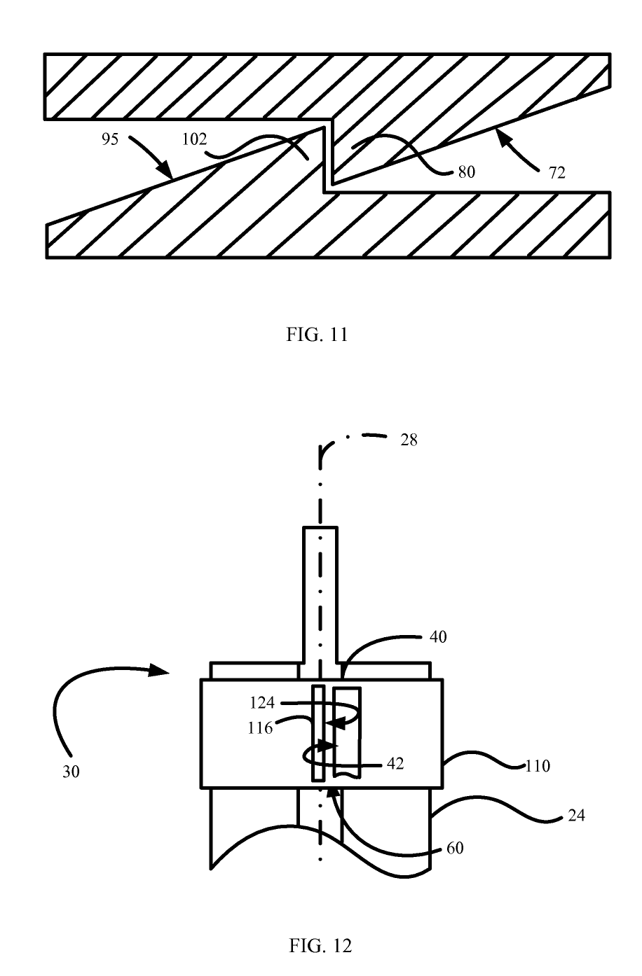

Referring to both FIGS. 9 and 10, end 30 includes shaft 90 that has a cross-sectional shape complementary to the shape of the hollow in rotor 18, which is to receive shaft 90. To that end, shaft 90 has a cross-section that is radially symmetrically disposed about axis 28. Extending radially outwardly at one end of shaft 90 are serif regions 91, 92, 93 and 94. Each of serif regions 91, 92, 93 and 94 includes a crown surface 95, described with reference to serif 93. Crown surface 95 extends from shaft 90, terminating in a transverse side 97. Opposed sides 99 and 101 extend from transverse side 97, parallel to one another and transversely to transverse side 97, terminating in adjacent serif regions 91-94. Crown surface 95 extends from side 99, forming an oblique angle σ with respect to a plane 103, terminating spaced-apart from opposing side 101 defining a shoulder portion 102 may form an interference with shoulder 80 in one direction, shown in FIG. 11. Oblique surface 72 and crown surface 95 allow substantially free movement between rotor 18 and resilient member 24 in the opposite direction.

In operation, kinetic energy is transferred from resilient member 24 to rotor 18 by the contact between shoulder portion 102 with shoulder 80. Oblique angles φ and σ formed by oblique surface 72 and crown surface 95 allow rotor 18 to continue spinning substantially freely about axis 28 after resilient member 24 has released substantially all potential energy in response to the release. Additionally, the shape of oblique surface 72 and crown surface 95 facilitate movement of resilient member 24 in response to torsional force τ₁, while reducing, if not avoiding movement of rotor 18. In this manner, the rotation of rotor 18 may be controlled so as to occur in a single direction, e.g., clockwise or counter-clockwise.

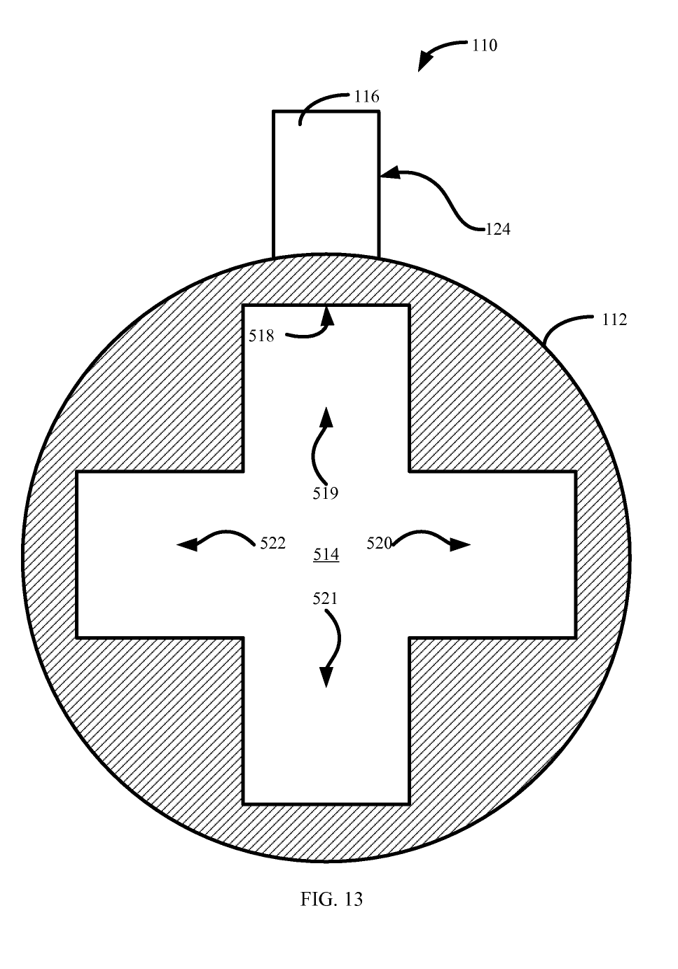

Referring to both FIGS. 12 and 13, in a second embodiment, capillary action with body 40 occurs by implementing a journal member 110 that includes a trunk 112 having a throughway 514 and a detent 116 extending from trunk 112. Throughway 514 defines a surface 518 having a profile complementary to a profile of a region of resilient member 24 around which trunk 112 is positioned. In the present example, trunk 112 is disposed to be in superimposition with a region of resilient member 24 having the cruciform cross-section. Surface 518 defines four serif recesses 519, 520, 521 and 522, each of which is to receive a portion of one of projections 32, 34, 36 and 38. The relative dimensions of throughway 514 and resilient member 24 are established so that rotation of journal member 110 about axis 28 produces torsional force τ₁ on resilient member 24. To that end, detent 116 includes a surface 117 that faces surface 42 so that capillary action may be generated therebetween, as discussed above.

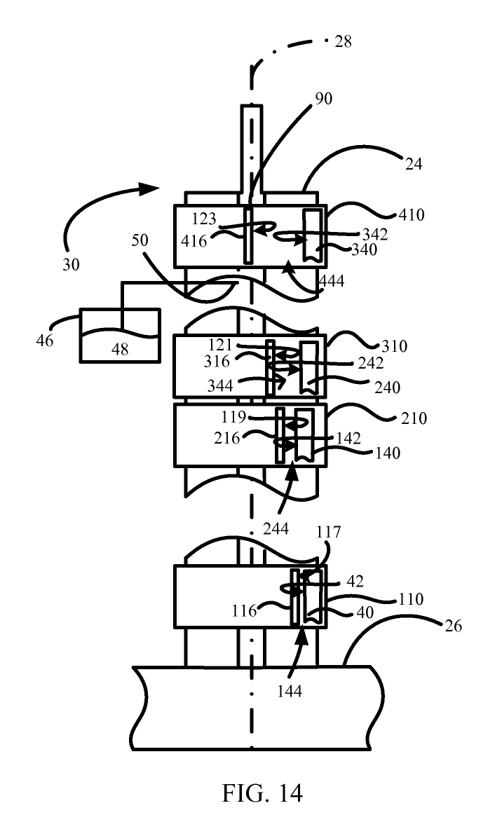

Referring to FIG. 14, in another embodiment the potential energy stored in resilient member 24 may be augmented by disposing a plurality of journal members, shown as 110, 210, 310 and 410 along different portions of resilient member 24. Each journal members 210, 310 and 410 includes the features described above with respect to journal member 110. As such a plurality of detents 116, 216, 316 and 416 are situated at about axis 28 at different distances from bulwark 26, as are a plurality of corresponding bodies 40, 140, 240 and 340. Each of bodies 40, 140, 240 and 340 includes a surface located at a different angular position with respect to axis 28 and may have a spatial position with respect to bulwark 26 that is fixed, as discussed above with respect to body 40. Body 40 includes surface 42, bodies 140, includes surface 142, body 240 includes surface 242 and body 340 includes surface 342.

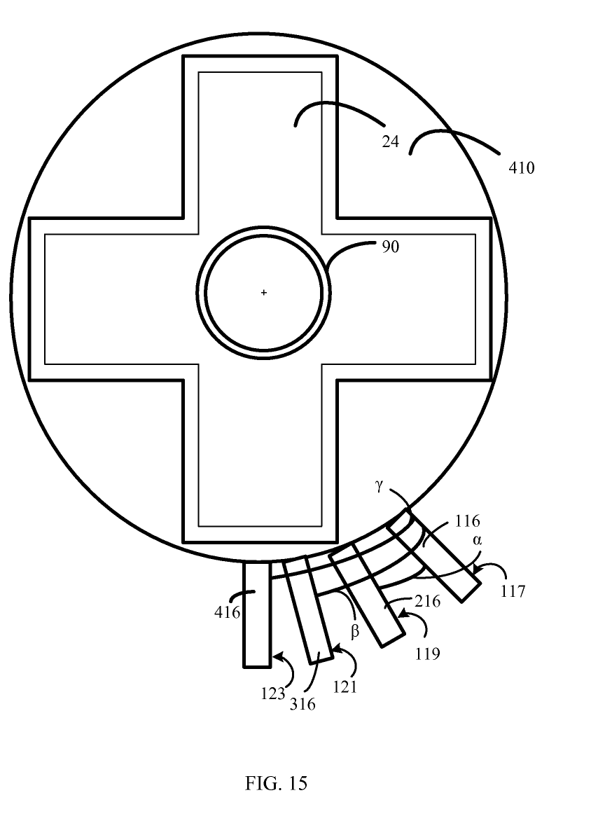

Referring to both FIGS. 14 and 15, using detent 116 as a starting point, the angular position of surfaces 119, 121 and 123 form angles α, β, and γ, respectively, with respect to surface 117. In this manner, surfaces are arranged about axis 28 at different angular positions. Angle β is greater than angle α and less than angle γ, with γ being the largest angle. The relative angular position of surfaces 117, 119, 121 and 123 are established to produce torsional forces τ₁, τ₂, τ₃ and τ₄ on resilient member 24. To that end, surface 117 is in juxtaposition with and spaced-apart from surface 42 of body 40, defining volume 144 therebetween. Egress 50 of supply 46 is positioned to deposit a portion of fluid 48 into volume 144 so that upon application thereof on one or both surfaces 117 and 42 capillary action occurs pulling surfaces 117 and 42 closer together, as discussed above. This produces first torsional force τ₁ that causes rotation of resilient member 24. As discussed above, restoring force F_{R1} and torsional force τ₁ reach equilibrium, i.e. no further movement of resilient member 24 as a result of first torsional force τ₁.

Angle α is established so that upon restoring force F_{R1} and torsional force τ₁ reaching equilibrium a second volume 244 is generated between a surface 119 of detent 118 and surface 142, which is in juxtaposition with and spaced-apart therefrom. The dimensions of volume 244 are established so that capillary action may occur between a portion of fluid 48 deposited therein and surfaces 119 and 142. This produces a second torsional force τ₂. It is desired that second torsional force τ₂ be greater than first restoring force F_{R1} in order to increase deformation of resilient member 24 and, therefore, increase the potential energy stored therein. To that end volume 244 is established to be greater than volume 144. For a given fluid 48 this may be achieved by providing greater areas of surfaces 119 and 142 that are in juxtaposition, when compared to the areas of surfaces 42 and 117 with the understanding that the distance between surfaces 119 and 142 are the same as the distances between surfaces 119 and 142 when capillary action occurs. Alternatively, volumes 144 and 244 may have common dimensions the fluid (not shown) deposited between surfaces 119 and 142 may be a different fluid the portion of fluid 48 between surfaces 117 and 42 such that a intermolecular forces with surfaces 119 and 142 is generated. To that end, a second supply of fluid (not shown) may be included to provide the different fluid. In the present embodiment egress 50 and/or supply 46 may move with respect to resilient member 24 to deliver fluid 48 in the appropriate volumes, e.g., 144, 244, 344 and 444. In response to being subjected to torsional force τ₂, resilient member 42 undergoes further deformation increasing the restoring force, referred to as a second restoring force F_{R2}. Deformation, and therefore movement, of resilient member 42 ceases upon torsional force τ₂ and second restoring force F_{R2} reaching equilibrium.

Angle β is established so that upon second restoring force F_{R2} and second torsional force τ₂ reaching equilibrium a second volume 344 is generated between a surface 121 of detent 120 and surface 242, which is in juxtaposition with and spaced-apart therefrom. The dimensions of volume 344 are established so that capillary action may occur between a portion of fluid 48 deposited therein and surfaces 121 and 242 to produce a third torsional force τ₃. It is desired that third torsional force τ₃ be greater than second restoring force F_{R2} in order to increase deformation of resilient member 24 and, therefore, increase the potential energy stored therein. To that end volume 344 is established to be greater than volume 244, which may be achieved as discussed above with respect to volumes 144 and 244. In response to being subjected to third torsional force τ₃, resilient member 42 undergoes further deformation increasing the restoring force, referred to as a third restoring force F_{R3}. Deformation, and therefore movement, of resilient member 42 ceases upon third torsional force τ₃ and third restoring force F_{R3} reaching equilibrium.

Angle γ is established so that upon third restoring force F_{R3} and third torsional force τ₃ reaching equilibrium a fourth volume 444 is generated between a surface 123 of detent 122 and surface 342, which is in juxtaposition with and spaced-apart therefrom. The dimensions of fourth volume 444 are established so that capillary action may occur between the portion of fluid 48 deposited therein and surfaces 123 and 342 to produce a fourth torsional force τ₄. It is desired that fourth torsional force τ₄ be greater than third restoring force F_{R3} in order to increase deformation of resilient member 24 and, therefore, increase the potential energy stored therein. To that end, fourth volume 444 is established to be greater than third volume 344, which may be achieved as discussed above with respect to volumes 144 and 244. In response to being subjected to fourth torsional force τ₄, resilient member 42 undergoes further deformation increasing the restoring force, referred to as a fourth restoring force F_{R4}. Deformation, and therefore movement, of resilient member 42 ceases upon fourth torsional force τ₄ and fourth restoring force F_{R4} reaching equilibrium.

The potential energy stored in resilient member 24 may be released by disturbing the aforementioned equilibrium, as discussed above. For example, a mechanical force may be applied to any one of detents 140, 240, 340 and 440 to create pulling force F_{P} that moves in a direction away from resilient member 24. It is desired that pulling force F_{P} have sufficient magnitude to overcome the intermolecular forces present in any one of volumes 144, 244, 344 and 444. The combination of fourth restoring force F_{R4} and pulling force F_{P} act in opposite directions to disrupt the aforementioned equilibrium and degrade the capillary action of one or more the portions of fluids present in volumes 144, 244, 344 and 444 when one or more detents 140, 240, 340 or 440 is subjected to pulling force F_{P}. In one example, pulling force F_{P} may act upon detent 440 that would result in the degradation of the intermolecular forces between the portion of fluid present in volume 444 and surface 123 and 442. Considering that fourth restoring force F_{R4} is greater than any one of first torsional force τ₁ second torsional force τ₂ and third torsional force τ₃, the kinetic energy produced by fourth restoring force F_{R4} would overcome the intermolecular forces in each of volumes 144, 244 and 344 to allow resilient member to return to the original shape. In one mode of operation pulling force F_{P} is provided in the manner, discussed above with respect to FIG. 6. To that end, an additional body (not shown) may be positioned proximate to each of bodies 116, 216, 316 and 416 to define a volume therebetween, creating a plurality of pulling volumes, of appropriate dimensions such that supply 46 may deposit a portion of fluid 28 therein. In this manner, supply 46 may be employed to sequentially deposit portion of fluids in the appropriate volumes 144, 244, 344 and 444 and one or more pulling volumes (not shown) to allow resilient member 24 to continuous deform and return to an original shape to maintain movement of rotor, shown in FIG. 1, at a substantially continuous velocity to generate electricity.

The presence of intermolecular forces in volumes 144, 244 and 344 during release of molecular forces in volume 444 may result in attenuation of kinetic energy produced by resilient member 24, as well as disrupt the angular velocity of rotor 20 when subjected to the movement of resilient member 24. To reduce, if not avoid, these deleterious effects, it may be advantageous to release the intermolecular forces in one or more, and possibly all, of volumes 144, 244 and 344, before releasing intermolecular forces in volume 444. It is entirely possible that release of the intermolecular forces in one or more, and possibly all, of volumes 144, 244 and 344 may result in release of intermolecular forces in volume 444 before application of pulling force F_{P} to detent 122. This may also result in attenuation of kinetic energy produced by resilient member 24 returning to the original shape. To avoid this situation one embodiment may include providing volume 444 with dimensions sufficient so that the intermolecular forces generated by the portion of fluid 48 present therein are of sufficient magnitude to maintain equilibrium with fourth restoring force F_{R4} in the absence of any one of first torsional force τ₁, second torsional force τ₂, and third torsional force τ₃. In this configuration it is possible to release intermolecular forces in each of volumes 144, 244 and 344 while maintaining equilibrium with both restoring fourth force F_{R4} and of any one of fourth torsional force τ₄. Thereafter, intermolecular forces in fourth volume 444 may be released by applying pulling force F_{P} to detent 416.

It should be understood that the description recited above is list examples of the invention and that modifications and changes to the examples may be undertaken which are within the scope of the claimed invention. Therefore, the scope of the appended claims should be accorded the broadest interpretation so as to encompass all such modifications and similar arrangements, including a full scope of equivalents.

1. A system for generating electrical energy comprising:
a resilient member having an original shape extending along a longitudinal axis;
a bulwark connected to said resilient member;
a PKE sub-system to selectively apply a torsional force to said resilient member using capillary forces to rotate said resilient member with respect to said bulwark, providing said resilient member with a deformed shape, and terminate said capillary forces allowing said resilient member to return to said original shape; and
an electrical generator sub-system having a rotor and a stator, with said rotor coupled to said resilient member to spin in response to said resilient member changing from said deformed shape to said original shape.

2. The system as recited in claim 1 wherein said resilient member further includes a shoulder and said PKE sub-system further includes a first body having a first body surface spaced-apart from said shoulder a distance, defining a first volume therebetween and a supply of fluid having a first egress disposed to deposit a portion of fluid of said supply in said volume, with said distance being established to generate capillary action with said portion disposed therebetween and cause said distance to reduce imparting rotational movement between said resilient member and said bulwark about said longitudinal axis.

3. The system as recited in claim 2 wherein said system further includes a second body, spaced-apart from said first body and having a second body surface facing an additional surface and spaced-apart therefrom a second distance, defining a second volume therebetween, with said supply configured to deposit a second portion into said second volume, with said second volume being established to generate capillary action to terminate capillary action in said first volume.

4. The system as recited in claim 1 wherein said system further includes a journal member having a throughway, through which resilient member passes, and a detent 116 extending from said journal member.

5. The system as recited in claim 1 wherein said PKE sub-system further includes a journal member having a throughway, through which resilient member passes, and a detent extending from said journal member and a first body a first body having a first body surface spaced-apart from detent a distance, defining a first volume therebetween and a supply of fluid having a first egress disposed to deposit a portion of fluid of said supply in said volume, with said distance being established to generate capillary action with said portion disposed therebetween and cause said distance to reduce imparting rotational movement between said resilient member and said bulwark about said longitudinal axis.

6. The system as recited in claim 1 wherein said PKE sub-system includes a plurality of journal members disposed along different portions of said resilient member and a plurality of first bodies, with each of said plurality of journal members having a throughway, through which said resilient member passes, and a detent extending from said journal member with each of said plurality of first bodies being in juxtaposition with one of the detent of one of the plurality of journal members to sequentially defining a plurality of detent first body pairs, with said plurality of pairs arranged to sequentially define a plurality of volumes therebetween to facilitate generation of capillary action within said volume in the presence of a portion of liquid.

7. The system as recited in claim 6 wherein said PKE sub-system further includes a supply of fluid to deposit said fluid into said plurality of volumes.

8. The system as recited in claim 1 wherein said PKE sub-system includes a plurality of journal members disposed along different portions of said resilient member, a plurality of first bodies and a supply of liquid, with each of said plurality of journal members having a throughway through which said resilient member passes, and a detent extending from said journal member with each of said plurality of first bodies being in juxtaposition with one of the detent of one of the plurality of journal members defining a plurality of detent-first body pairs, with said plurality of pairs arranged to sequentially define a plurality of volumes therebetween to facilitate generation of capillary action within said volume in the presence of a portion of liquid, with said PKE sub-system configured to sequentially rotate said resilient member commencing with one of said plurality of journal member located closest said bulwark.

9. The system as recited in claim 1 wherein said PKE sub-system includes a plurality of journal members disposed along different portions of said resilient member, a plurality of first bodies and a supply of liquid, with each of said plurality of journal members having a throughway, through which said resilient member passes, and a detent extending from said journal member with each of said plurality of first bodies being in juxtaposition with one of the detent of one of the plurality of journal members defining a plurality of detent-first body pairs, with said plurality of pairs arranged to sequentially define a plurality of volumes therebetween to facilitate generation of capillary action within said volume in the presence of a portion of liquid, with said PKE sub-system configured to sequentially rotate said resilient member commencing with one of said plurality of journal member located furthest from said bulwark.

10. A method of generating electrical energy using an alternator having a rotor and a stator, said method comprising:
coupling a resilient member to said rotor, said resilient member having an original shape;
deforming said original shape by subjecting said resilient member to a torsional force through capillary action, placing said resilient member in a deformed shape; and
imparting rotation to said resilient member by terminating said torsional force through degradation of said capillary action thereby allowing said resilient member to return to said original shape.

11. The method as recited in claim 10 further including sequentially imparting additional torsional forces to said resilient member along different portions of a length thereof.

12. The method as recited in claim 10 further including sequentially imparting a plurality of torsional forces to said resilient member along a plurality different portions of a length thereof, with a first of said plurality of torsional forces being applied to one of said plurality of different portions located furthest from said rotor and the last of said plurality of torsional forces in said sequence being applied to an additional of said plurality of different portions located closest to said rotor.

13. The method as recited in claim 10 further including sequentially imparting a plurality of torsional forces to said resilient member along a plurality different portions of a length thereof, with a first of said plurality of torsional forces being applied to one of said plurality of different portions located closest to said rotor and the last of said plurality of torsional forces in said sequence being applied to an additional of said plurality of different portions located farthest from said bulwark.

14. The method as recited in claim 10 further including sequent sequentially applying additional torsional forces to said spring to impart angular movement of said spring about a longitudinal axis thereof.

15. The method as recited in claim 10 further including sequentially imparting a plurality of torsional forces to said resilient member along a plurality different portions of a length thereof, with a first of said plurality of torsional forces being applied to one of said plurality of different portions located furthest from said rotor and the last of said plurality of torsional forces in said sequence being applied to an additional of said plurality of different portions located closest to said bulwark and terminating further includes terminating said last torsional forces after all other torsional forces have been terminated.

16. The method as recited in claim 10 further including sequentially imparting a plurality of torsional forces to said resilient member along a plurality different portions of a length thereof, with a first of said plurality of torsional forces being applied to one of said plurality of different portions located furthest from said rotor and the last of said plurality of torsional forces in said sequence being applied to an additional of said plurality of different portions located closest to said rotor and terminating further includes terminating said last torsional forces after one of the other torsional forces have been terminated and before any additional torsional forces have been terminated.
